(19) United States
(12) Patent Application Publication
(10) Pub. No.: US 2009/0224555 A1
(43) Pub. Date: Sep. 10, 2009

(54) Load Supporting Frame Multi-Level Wind Turbine Generator

(76) Inventor: Xie ZHENCAI, Shenzhen City (CN)

Correspondence Address: TROXELL LAW OFFICE PLLC, 5205 LEESBURG PIKE, SUITE 1404, FALLS CHURCH, VA, 22041, US

(21) Appl. No.: 12/412,517

(22) Filed: Mar. 27, 2009

(30) Foreign Application Priority Data
Nov. 28, 2006 (CN) 200610157178.2

(51) Int. Cl. F03D 9/00

(52) U.S. Cl. 290/55

(57) ABSTRACT

A load supporting frame multi-level wind turbine generator includes a wind turbine, a wind turbine support frame, a transmission mechanism, and an electric generation device. The wind turbine includes a multilevel clockwise and counterclockwise rotating, different-diameter and longitudally arranged wind turbine set with a central fixing shaft installed on the wind turbine, a gear frame and a multilayer blade frame, and the blade frame has a blade, and a hydraulic contractor is coupled between the gear frame and the blade frame. The wind turbine further includes an oil pump connected to the hydraulic contractor through an oil pipe, and the wind turbine shaft installs an electrically conductive ring. The wind turbine support frame includes a circular stable frame connected to the ground. The circular stable frame includes a cross-shaped load rotating frame. The transmission mechanism includes a first gear box and a second gear box.

### BACKGROUND OF THE INVENTION

(a) Field of the Invention

The present invention relates to a wind generating device, in particular to a load supporting frame multi-level wind turbine generator.

(b) Description of the Related Art

As the development of our society and living standard advance, people have an increasingly higher demand on energy sources, and energy shortage or crisis becomes an urgent issue that demands immediate attentions and requires feasible solutions for an economic and environment energy source. At present, major international energy providers usually adopt a three-blade propeller wind generator for the solutions but the structure of this kind of generators still has the following technical issues: 1. Three vanes are extended from a single blade and fixed to a center by prying forces, and thus it is difficult to develop a large-scale wind turbine. Even if the extended vanes are enhanced, it is necessary to increase the size of the central shaft. Such arrangement not only fails to improve the wind catching effect, but also increases the wind resistance. The longer the extended vane, the larger is the interval between the vanes along the periphery. As a result, the wind resource is wasted. 2. No adjustment or a small adjustment of the three-vane blade can be made. Electricity can be generated by winds at levels 3-7 only. Any wind at a level over level 7 may cause overloads or overheat to the generator, and thus the time of a full load power generation with the most effective wind performance will be wasted. As we know, an hour of a full load power generation is equivalent to an effect of having a wind power at levels 3-4 for several tens of hours. 3. The gravitational force of the three-vane blade at the center of internal diameter is unable to provide sufficient inertia or adjust the influence of an irregular gusty wind. As a result, the rotation speed is non-uniform; the voltage is unstable; the wind generation cannot be installed directly to an electric network; and the cost and power consumption are increased due to the expensive charging/discharging equipments. 4. At preset, there is no hoist for hoisting heavy objects at a height over 100 meters directly, and it is difficult to develop the large-scale wind turbine. 5. The economic effect is low and the cost is high.

China Pat. Nos. ZL200520061167.5 and CN200610157178.2 issued to Xie, Zhencai disclose a load supporting frame multi-level wind turbine generator.

### SUMMARY OF THE INVENTION

In view of the foregoing shortcomings of the prior art, the inventor of the present invention discloses a load supporting frame multi-level wind turbine generator in accordance with the present invention to overcome the difficulties of developing a large-scale wind turbine for three-blade wind turbine generations, making a large-angle adjustment to the blade, achieving a more effective way of catching winds and resisting typhoons and solve the technical issues of having a poor inertia of the wind turbine, an non-uniform rotation speed and an unstable voltage. As disclosed in China Pat. Nos. ZL200520061167.5 and CN200610157178.2 issued to Xie, Zhencai, a load supporting frame multi-level wind turbine generator is provided.

To achieve the foregoing objective, the present invention provides a “load supporting frame multi-level wind turbine generator”, and the level and the size of a wind turbine can be set according to actual requirements. For example, a third-level wind turbine generator with a capacity of 35,000 Kw and a wind turbine with a diameter of 286.8 m includes a central shaft and a circular stable frame connected to the ground, a rotor installed at a cross-shaped load rotating frame on the circular stable frame, a support frame and a generator installed on the cross-shaped load rotating frame, and a multilevel frame wind turbine set with different diameters having a windward direction instructing device, and each wind turbine installs a hydraulic gear pump and a hydraulic contractor, a conductive ring electrically coupled to an external power supply, and the middle of the cross-shaped load rotating frame installs a first gear box, and the top of the support frame installs a second gear box corresponding to the first gear box, and the second gear box, the first gear box and the second gear box are coupled through internal and external transmission shafts.

The wind turbine includes a multilevel, multilayer, different-diameter, longitudinally arranged wind turbine set, and the wind turbine is installed on a central fixing shaft, wherein the wind turbine includes a gear frame, a blade frame having a blade and a blade shaft, a contractor connected between the gear frame and the blade frame, an oil pump installed in the wind turbine and connected to the contractor through an oil pipe, and an electrically conductive ring installed on a wind turbine shaft.

The wind turbine support frame includes a circular stable frame connected to the ground, a cross-shaped load rotating frame installed on the circular stable frame, a roller installed between the circular stable frame and the cross-shaped load rotating frame, and a front pulling frame, a rear supporting frame, a side propping frame, a load bearing frame, a tensile frame, and a propping frame fixed onto the cross-shaped load rotating frame, and an upper end of the aforementioned frames is connected to a central fixing shaft.

The transmission mechanism includes a first gear box installed at the middle of the cross-shaped load rotating frame, a second gear box installed at the top of the support frame, and internal and external transmission shafts connected between the first gear box and the second gear box.

The first gear box includes upper and lower large conical gears installed at specific levels in the box body, and a first conical gear installed between and engaged with the upper and lower large conical gears, wherein the upper large conical gear is inserted vertically into a lower end of the external transmission shaft of the box body, and the lower large conical gear is coupled to the internal transmission shaft, and an axle of the generator is coupled to an axle of the first conical gear.

The second gear box includes a main transmission shaft vertically installed in the box body, a second conical gear installed at an upper end of the main transmission shaft, a third conical gear sheathed to a lower end of the main transmission shaft, and left and right large conical gears installed on and engaged to both sides of the second and third conical gears respectively, such that the lower end of the main transmission shaft is passed out from the box body and coupled to the upper end of the internal transmission shaft, and the lower end of the third conical gear is extended out from the box body and coupled to the upper end of the external transmission shaft.

The wind turbine set is formed by first-, second- and third-level frame wind turbines installed sequentially by a coaxial cable, wherein a previous level of a wind turbine equals to the next level with an increment increased according to a specific ratio, and the first-level wind turbine is installed directly onto an axle of a conical gear in the left and right large conical gears, and the second-level and third-level wind turbines have a pair of planetary gear systems with different transmission ratio and installed on left and right sides for linking left and right large conical gears.

In a preferred embodiment of the present invention, the pair of planetary gear systems are installed symmetrically at backs of the left and right large conical gears, and the planetary gear systems include a center gear fixed and sheathed onto axles of the left and right large conical gears in the second gear box, and connected to an internal gear through a support frame and a second gear box body fixed to an internal circumference. The four pieces of uniformly arranged planetary gears, and each planetary rotating arm shaft constitute a bushing extended outside the second gear box body and sheathed into a hollow axle of the left and right large conical gears, and the second-level wind turbine and third-level wind turbine are connected to the hollow axles of the left and right planetary gear systems, installed together with the first-level wind turbine to the wind turbine set sequentially.

In the pair of planetary gear systems, the planetary gear system connected to the second-level wind turbine has a transmission ratio of 2:1 and the planetary gear system connected to the third-level wind turbine has a transmission ratio of 2.87:1.

The rotor installed individually at distal top ends of vertical and horizontal beams of the cross-shaped load rotating frame and disposed on the circular stable frame includes first-, second- and third-level driving gear modules, and each level driving gear module is formed by arranging a plurality of driving gears, and an end of a gear shaft of each driving gear has a hydraulic driving machine controlled by a windward direction instructing device, and the circular stable frame has upper and lower cross-sections in a ladder shape, and an external wall in the upper ladder shape of the circular stable frame includes a protruded circular rail, and the first- and third-level driving gear modules have a roller installed at a level on upper and lower ladder shaped surfaces of the circular stable frame, and the roller of the second-level driving gear module is vertically installed at an external circumference of the circular rail.

The first-level driving gear module is coupled to the bottom of an external end of the cross-shaped load rotating frame through the support frame, and a rubber layer is disposed at an external circumference of the roller. The internal side of the support frame of the cross-shaped load rotating frame has a channel steel having a curvature corresponding to the circular rail. The second-level driving gear module is vertically installed in the channel steel 17, and the roller of the driving gear module has a retaining ring installed at a lower end of the roller, and an axle section on both sides of the third-level driving gear module includes a support board, and a load carrying board made of a layer of steel plate and a rubber pad disposed on the steel plate is installed between two support boards. The bottom of the cross-shaped load rotating frame has two connecting elements with a longitudinal slot, and an upper end of the support board is connected into the longitudinal slot of the connecting element by a pin axle, and a press plate is installed between two connecting elements for pressing the load carrying board.

The present invention adopts an symmetrically installed gear transmission mechanism, and the gear transmission mechanism is adjusted to rotate first-level and second-level wind turbines in a clockwise direction and a third-level wind turbine in a counterclockwise direction, so that a force is exerted onto support components such as gear shafts and bearings for a balance to stabilize the operation and extend the life of the equipment. If a strong wind is exerted onto the equipment, the equipment will be lifted slightly upward and slantingly, and thus the wind can be slowed down a bit to protect rotors effectively. Compared with the prior art, the present invention improves the utilization rate of the wind. A first gear box is installed proximate to a generator and a high-speed inertia wheel is installed to stabilize the rotation speed of the electric generator effectively to supply stable voltage, so as to improve the electric power generation effect.

The present invention has the following advantages:
1. The large-scale wind turbine is developed by using frames, and thus high-altitude winds can be used.
2. The multilevel wind turbine is used for clockwise and counterclockwise rotations to reduce frictional forces, and the linear speed of large and small wind turbines can be used for enhancing the wind-catching capability.
3. A large-angle adjustment of the blade can improve the typhoon resistance and increase the full load power generation time.
4. The carrying and rotating frame installed with a large-span pyramid support frame provides a secured, reliable and safe way of generating electric power.
5. Gravitational rotation is used to reduce the influence of gusty wind to stabilize the rotation speed and the voltage.
6. The cost-effectiveness is improved, and the cost is lowered.

### BRIEF DESCRIPTION OF THE DRAWINGS

The present invention will now be described in more detail hereinafter with reference to the accompanying drawings that show various embodiments of the invention as follows.

FIG. 1 is a schematic view of a preferred embodiment of the present invention;

FIG. 2 is a left side view of FIG. 1;

FIG. 3 is a schematic view of coupling a circular stable frame with a cross-shaped load rotating frame in accordance with a preferred embodiment of the present invention;

FIG. 4 is a schematic cross-sectional view of a first gear box in accordance with a preferred embodiment of the present invention;

FIG. 5 is a schematic cross-sectional view of a second gear box in accordance with a preferred embodiment of the present invention;

FIG. 6 is a schematic view of a planetary gear system in accordance with a preferred embodiment of the present invention;

FIG. 7 is a cross-sectional view of a rotor along the radial direction of a circular stable frame in accordance with a preferred embodiment of the present invention; and

FIG. 8 is a schematic view of coupling a frame in accordance with a preferred embodiment of the present invention.

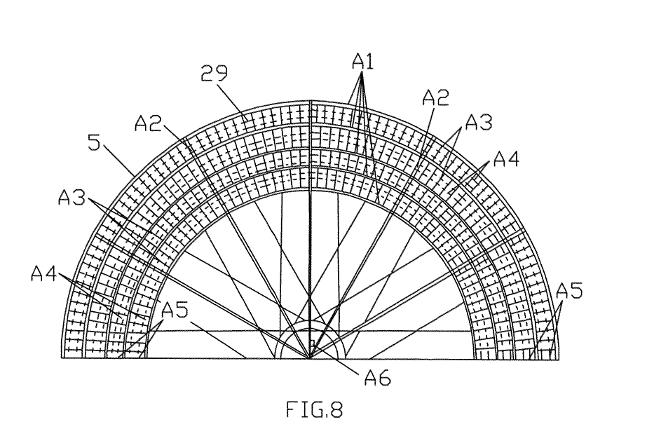

### DETAILED DESCRIPTION OF THE PREFERRED EMBODIMENTS

The present invention will now be described in more detail hereinafter with reference to the accompanying drawings that show various embodiments of the invention as follows.

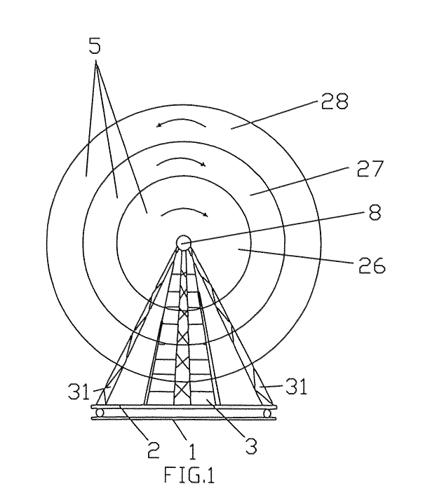

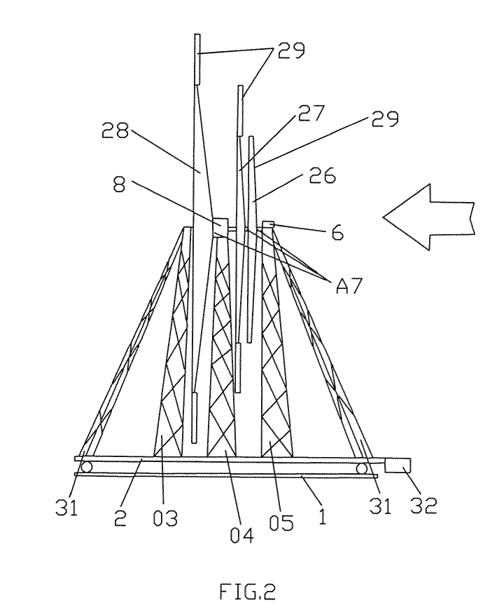

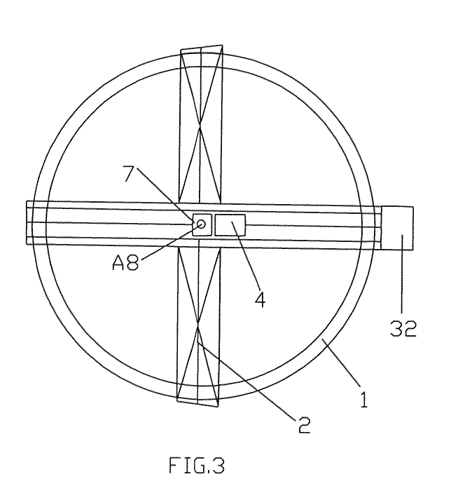

With reference to FIGS. 1 and 2 for a basic structure in accordance with a preferred embodiment of the present invention, a load supporting frame multi-level wind turbine generator comprises a circular stable frame 1 connected to the ground (as shown in FIG. 3), and a cross-shaped load rotating frame 2 installed on the circular stable frame 1 through a set of rotors. The cross-shaped load rotating frame 2 installs a propping frame 03, a load bearing frame 04 and a tensile frame 05 sequentially to form a support frame, and the support frame has a subsidiary support frame 31 at the front, rear, left and right sides of the support frame individually, such that a subsidiary support frame 31 of a pyramid structure having a primary front-to-rear and secondary left-to-right support structure. The support frame 31 has a wind turbine set 5 composed of a plurality of frame wind turbines with different diameters installed at the top level of the support frame 31, and each wind turbine 5 (as indicated by A in the figures) of the wind turbine set includes a primary frame A2 and a blade frame A3 stably and uniformly installed radially on a circular multi-level frame A1. The wind turbine set 5 is formed by installing first-, second- and third-level frame wind turbines 26, 27, 28 by coaxial cables, and the previous level of the wind turbine is incremented to the next level according to a specific ratio, wherein the first-level wind turbine 26 has a radius equal to 51 meters, and the second-level wind turbine 27 has a radius equal to 102.2 meters, and the wind catching side of the blade is installed in a counterclockwise direction, and the third-level wind turbine 28 has a radius equal to 143.5 meters, and the wind catching side of the blade is installed in a clockwise direction. The first-level wind turbine 26 has a blade 29 installed in the radial direction, and a blade 29 is installed in an annular region formed by the difference of diameters between the next-level secondary wind turbine and the previous-level wind turbine, and no blade is installed in the overlapped region. Each blade comes with a length of 9.8 meters and a width of 2 meters, and the blades are arranged uniformally and axially on a plurality of layers, and an axial center is used for sheathing onto the blade frame A3, and the interval between the blades is designed to have a windward area smaller than the draught area, and each of the first and second-level wind turbines has five layers, and the third-level wind turbine has four layers, and all blades are controlled by a central controller. The central controller includes an electrically conductive ring A7 disposed at an end of each wind turbine and connected to an external power supply, an electric hydraulic pump A6 installed at the middle position of each wind turbine for linking the stable primary frame through a pipe and a hydraulic contractor A5 connected to the circular link rod for linking the blade through a circular link rod A4. The wind attack angle of the blade 29 can be adjusted according to the wind force, and the adjusted angle ranges from 10 degrees to 45 degrees to accomplish the best wind-catching angle and typhoon resistance of the blade 29. The cross-shaped load rotating frame 2 has a first gear box 7 (as shown in FIG. 3) disposed proximate to the central position of the cross-shaped load rotating frame 2, and the load bearing frame 04 has a second gear box 8 installed at the top of the load bearing frame 04 and erected at a position corresponding to the first gear box 7, and the first gear box 7 and the second gear box 8 are coupled by internal and external transmission shafts 9, 10. In the practical application of the internal and external transmission shafts 9, 10, their lengths causes a high level of difficulty to the manufacture, and an inconvenient installation, and thus the internal and external transmission shafts 9, 10 of this preferred embodiment are made by connecting a plurality of sections, and the sections are connected and secured with each other by snap clasps and sheath threads.

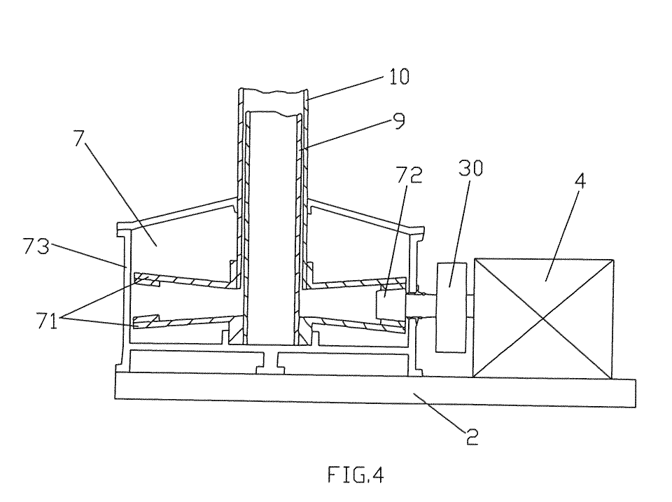

In FIG. 4, the first gear box 7 includes upper and lower large conical gears 71 installed at an internal gear surface of the first gear box body 73 and at a level corresponding to the coaxial center, a first conical gear 72 installed and engaged with the upper and lower large conical gears 71, and the upper large conical gear is installed at a lower end of an external transmission shaft 10 which is vertically inserted into the first gear box 7, and the lower large conical gear is installed at a lower end of the internal transmission shaft 9. A generator 4 is installed adjacent to the first gear box and coupled to an axle of the first conical gear 72 in the first gear box 7 through an inertia wheel 30. When the generator 4 is operated, a large fluctuation of rotation speed of generator 4 is caused by gusty winds, and the voltage becomes unstable. Since the inertia wheel 30 is installed at an axle of the generator, and the inertia wheel 30 generally comes with a weight of eight tons and a heavy-weight wind turbine, therefore a stable rotation speed of the generator can be achieved by the inertia of the rotating operation.

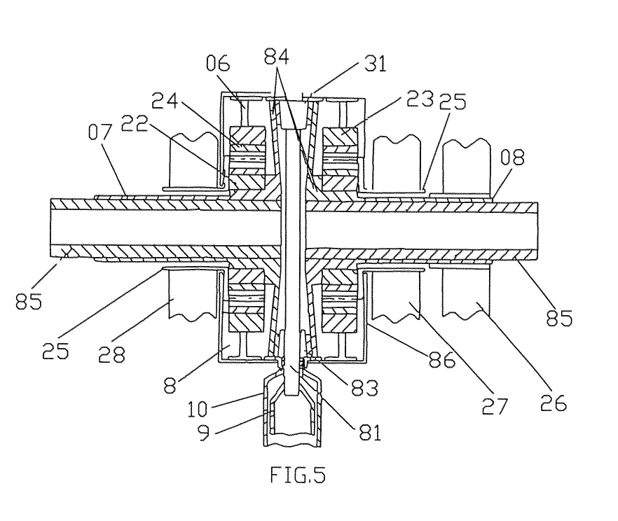

In FIG. 5, the second gear box 8 comprises: a main transmission shaft 81 vertically installed in the box body, and having a second conical gear 82 installed at an upper end of the main transmission shaft 81, and a lower end passed through the second gear box body 86 and coupled to an upper end of the internal transmission shaft 9, and a third conical gear 83 installed at the bottom of the second gear box 8 and symmetrically installed with the second conical gear 82 and sheathed to a lower end of the main transmission shaft 81, wherein the lower end is extended out from the second gear box 8 and coupled to an upper end of the external transmission shaft 10. The second and third conical gears 82, 83 have left and right large conical gears 84 installed on both left and right sides and engaged with each other. The first-level wind turbine 26 of the wind turbine set 5 is the wind turbine with an original speed and the second-level and third-level wind turbines 27, 28 installed on a hollow shaft 08 of the right large conical gear 84 have a pair of left and right symmetric planetary gear systems for linking the left and right large conical gears 84, and the left and hollow shafts 07, 08 of the right large conical gears 84 are sheathed onto a central fixing pipe 85.

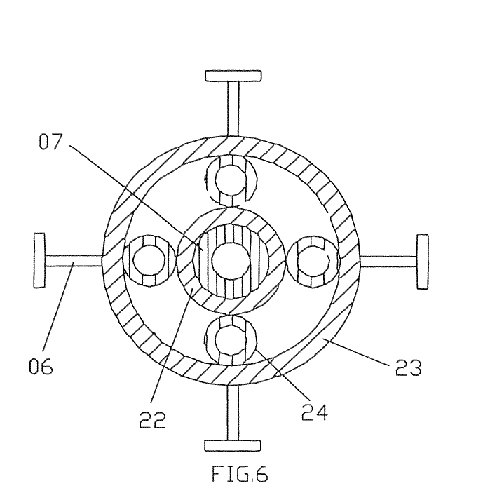

In a preferred embodiment adopting the following structure and installation of the planetary gear system (as shown in FIGS. 5 and 6), wherein two sets of planetary gear systems are used, and symmetrically installed at a wheel back of the left and right large conical gears, The planetary gear system includes a center gear 22 fixed and sheathed to a hollow shaft 07, 08 of the left and right large conical gears 84 in the second gear box 8, and coupled to an internal gear 23 through the internal circumferences of the support rod 06 and the second gear box body 86. Four pieces of uniformly disposed planetary gears 24 are used, and each planetary rotating arm shaft constitutes a bushing extended out from the second gear box body 86 and installed to the hollow axle 25 of the second-level wind turbine 27 or third-level wind turbine 28, and the axle is sheathed onto the hollow shaft 07, 08 of the left and right large conical gears. Since the internal gear 23 is a fixed gear, and the hollow shafts of the center gear 22 and the left and right large conical gears 84 are connected, the planetary gear 24 is rotated (with both rotation and revolution) to drive the center gear 22 and the left and right large conical gears 84 to rotate together. When the second or third-level wind turbine is rotated, the transmission ratio of the planetary gear systems can be calculated according to the actual conditions and the ratio of diameters of the wind turbines, such that the rotation speeds of the left and right center gears 22 and the first-level wind turbine 26 (which is the wind turbine with an original speed) can be maintained the same. In this preferred embodiment, the first-level wind turbine 26 is installed directly at the hollow shaft 08 of the right large conical gear 84, and the second-level wind turbine 27 is installed at the hollow axle 25 of the right planetary gear system. The right planetary gear system has a transmission ratio of 2:1, such that the rotation speed of the center gear 22 is equal to the rotation speed of the right large conical gear, and the first-level and second-level wind turbines can drive the right large conical gear to rotate at a harmonic rotation speed. The third-level wind turbine 28 is installed onto the hollow axle 25 of the left planetary gear system, and the left planetary gear system has a transmission ratio of 2.87:1, such that the rotation speed of the left center gear 22 is equal to the rotation speed of the left large conical gear in order to harmonize the rotation of the left and right large conical gears 84 and the second and third conical gears 82, 83.

From the aforementioned structure, the wind turbine of each level is exerted with wind to produce rotations to drive the left and right planetary gear systems, the left and right large conical gears 84, the main transmission shaft 81, the second and third conical gears 82, 83 in the second gear box 8 to rotate, and then the wind turbine is sheathed with the internal and external transmission shafts 9, 10 to transmit the upper and lower large conical gears 71 in the first gear box 7, and then the engaged first conical gear 72 is provided for rotating the axle of the generator, and an electrically conductive ring A8 is installed to the generator through the central shaft for transmitting current to an electric network to complete the whole process of converting wind energy into electric energy.

In FIGS. 1 and 2, the support frame includes a windward direction instructing device 6 installed on a windward side for issuing an instruction to drive a rotor, such that the cross-shaped load rotating frame 2 is rotated on the circular stable frame 1, and the wind turbine 360 can change the wind attack angle in a great extent to maximize the windward area of the wind turbine, wherein the right side of FIG. 2 is the windward side. In FIG. 3, a balanced basin 32 is installed at an end (on the right side) of a windward beam of the cross-shaped load rotating frame 2 for balancing the forces exerted onto the wind turbine to avoid the wind turbine from toppling. The balance basin 32 is capable of withholding a load of 1100 tons.

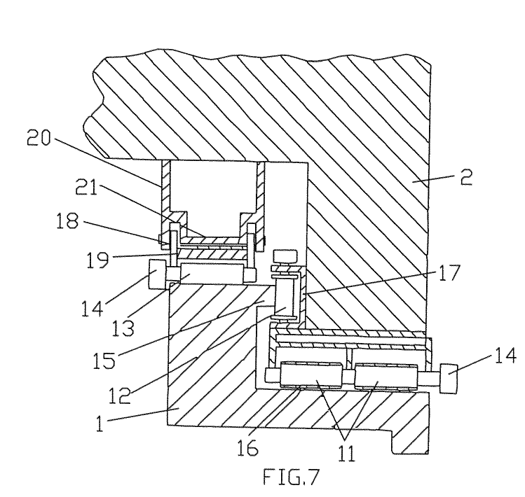

In FIG. 7, the rotors are installed at distal top ends of the vertical and horizontal beams of the cross-shaped load rotating frame 2 respectively and disposed on the circular stable frame 1. The device includes first-, second- and third-level driving gear modules 11, 12, 13, and a driving gear module of each level is formed by arranging a plurality of driving gears along an arc of the circular stable frame 1, and an end of each driving gear shaft has a hydraulic driving machine 14, and the windward direction instructing device 6 issues an instruction to turn on the hydraulic driving machine 14 to drive the cross-shaped load rotating frame 2 to rotate, such that the wind turbine can automatically change the wind attack angle in a great extent. In this preferred embodiment, the circular stable frame 1 has cross-sections in upper and lower ladder shapes, and the external wall of the upper ladder shaped cross section has a convex circular rail 15.

The driving gear in the first-level driving gear module 11 is a coaxial dual roller, and a rubber layer 16 is disposed on the external circumference of the roller, and the driving gear module 11 is coupled to the bottom at an external end of the cross-shaped load rotating frame 2 through the support frame, and installed at a level for pressing the lower ladder plane at the external periphery of the circular stable frame 1.

The support frame of the cross-shaped load rotating frame 2 has a channel steel 17 with a curvature corresponding to the circular rail 15, and the second-level driving gear module 12 is installed vertically in the channel steel 17, and upper and lower ends of the roller in the driving gear module 12 have a retaining ring, and an external circumferential surface of the roller is in contact with an external circumferential surface of the circular rail 15.

The third-level driving gear module 13 is disposed at a level corresponding to the upper ladder shaped plane of the cross-shaped load rotating frame 2, and a circular groove can be made on the ladder shaped plane, so that the roller can be installed in the groove for a circle movement. The driving gear module 13 of each level has a support board 18 installed on an axial section on both sides, and a load carrying board 19 installed between two support boards. The load carrying board 19 includes a steel plate and a rubber pad disposed on the steel plate. The bottom of the cross-shaped load rotating frame 2 has two connecting elements 20 with a longitudinal slot (not shown in the figure), and an upper end of the support board 18 is connected into the longitudinal slot of the connecting element 20 through a pin axle, such that the structure can slide the connecting element 20 to slide up and down with respect to the pin axle. A press plate 21 is installed between the two connecting elements 20 for pressing the load carrying board 19. Since the invention comes with a relatively large size, the cross-shaped load rotating frame 2 may be lifted slightly and slantingly when the wind turbine set is blown with strong winds. Therefore, a rotor provides up and down displacements for the cross-shaped load rotating frame 2, and the rubber pad of the load carrying board 19 and the rubber layer 16 on the outside of the roller of the first-level driving gear module 11 are provided for reducing the shocks, so as to prevent the rotor from being damaged by the strong winds exerted onto the wind turbine set.

The present invention adopts a frame multilevel wind turbine structure to enhance the wind-catching capability, such that when the first-level and second-level wind turbines are rotated clockwise and the third-level wind turbine is rotated counterclockwise, the structural combination of gears can be optimized to provide a balance of forces to components including the gear shaft, the bearings and the support frame, and achieve the effects of stabilizing the operation of the equipment and extending the using life. When a strong wind is exerted onto the equipments, the equipments can be lifted or tilted slightly for the shock absorption to protect the rotor effectively. In the construction, all wind turbine sets are soldered with the ground, and the tensile frame is used as a support point for erecting the equipments into their positions by several winding machines, and the whole process is also an on-the-spot survey process. The wind turbine has a weight of 1100 tons, and thus it is necessary to put the wind turbine flatly on the ground first, and then pull the wind turbine upward to its erected positions, before the welding process can be completed. The typhoon resistance is over 1100 tons to assure the required safety. Compared with the prior art, the present invention improves the wind using rate, and the generator is installed proximate to the first gear box and a high-speed inertia wheel is installed to effectively stabilize the rotation speed of the generator, supply a stable voltage and enhance the power generation efficiency.

While the invention has been described by means of specific embodiments, numerous modifications and variations could be made thereto by those skilled in the art without departing from the scope and spirit of the invention set forth in the claims.

I claim:

1. A load supporting frame multi-level wind turbine generator, comprising:
a wind turbine, having a multilevel, clockwise and counterclockwise rotating, different-diameter and longitudinally arranged wind turbine set, and installed on a central fixing shaft, and the wind turbine including a gear frame and a blade frame, and the blade frame including a multilayer blade, a blade shaft, a hydraulic contractor coupled between the gear frame and the blade frame, an oil pump installed in the wind turbine and coupled to the hydraulic contractor through an oil pipe, and an electrically conductive ring installed on a wind turbine shaft;
a wind turbine support frame, having a central shaft, an electrically conductive ring and a circular stable frame coupled to the ground, a cross-shaped load rotating frame disposed on the circular stable frame having, a roller installed between the circular stable frame and the cross-shaped load rotating frame, and each cross-shaped load rotating frame having a front pulling frame, a rear supporting frame, a side propping frame, a load bearing frame, a tensile frame, a propping frame for each support frame, and an upper end of each support frame being coupled to the central fixing shaft;
a transmission mechanism, including a first gear box installed at the middle of the cross-shaped load rotating frame, a second gear box installed at the top of the support frame, internal and external transmission shafts engaged with each other and coupled between the first gear box and the second gear box, and the first gear box including upper and lower large conical gears with a level aligned inside the box body, and a first conical gear installed between and engaged with the upper and lower large conical gears, and the upper large conical gear being coupled to a lower end of the external transmission shaft vertically inserted into the box body, and the lower large conical gear being coupled to a lower end of the internal transmission shaft, and an axle of the generator being coupled to an axle of the first conical gear, and the second gear box including a main transmission shaft vertically installed in the box body, a second conical gear installed at an upper end of the main transmission shaft, a third conical gear sheathed to a lower end of the main transmission shaft, left and right large conical gears engaged with each other and disposed on both left and right sides of the second and third conical gears, and the lower end of the main transmission shaft being passed through the box body and coupled to an upper end of the internal transmission shaft, and the lower end of the third conical gear being extended out from the box body and coupled to an upper end of the external transmission shaft; and
an electric generation device.

2. The load supporting frame multi-level wind turbine generator of claim 1, wherein the left and right large conical gears have a wheel back with a planetary gear system of a different transmission ratio, and the planetary gear system comprises: a center gear fixed and sheathed onto an axle of the left and right large conical gears in the second gear box and coupled to an internal gear through the internal circumferences of the support frame and the second gear box body, and each uniformly distributed planetary gear, and each planetary rotating arm shaft constitutes a bushing extended out from the second gear box body and sheathed to a hollow axle of the left and right large conical gears, and each level wind turbine is coupled to the hollow axle of the left and right planetary gear system, and installed together with the first-level wind turbine to form a wind turbine set.

3. The load supporting frame multi-level wind turbine generator of claim 1, wherein the cross-shaped load rotating frame includes vertical and horizontal beams, and a rotor installed individually at a distal top end of the vertical and horizontal beams, and the circular stable frame installs a driving gear module, and each driving gear module is formed by arranging a plurality of driving gears, and an end of a gear shaft of each driving gear has a hydraulic driving machine controlled by a windward direction instructing device, and a circular rail is protruded from an external wall of the circular stable frame, and the roller of the driving gear module is aligned with a level corresponding to the top of the circular stable frame and vertically installed at an external circumference of the convex circular rail.

4. The load supporting frame multi-level wind turbine generator of claim 3, wherein the driving gear module is coupled to the bottom at an external end of the cross-shaped load rotating frame through the support frame, and the roller has a rubber layer at an external circumference of the roller, and the internal side of the support frame of the cross-shaped load rotating frame has a channel steel with a curvature corresponding to the circular rail, and the second-level driving gear module is vertically installed in the channel steel 17, and the roller of the driving gear module has a retaining ring installed at upper and lower ends of the roller, and an axle section on both sides of the third-level driving gear module includes a support board, a load carrying board formed by a layer of steel plate and a rubber pad disposed on the steel plate and disposed between two support boards, and the bottom of the cross-shaped load rotating frame has two connecting elements with a longitudinal slot, and the upper end of the support board is coupled into the longitudinal slot of the connecting element through a pin axle, and a press plate is installed between the two connecting elements for pressing the load carrying board.

5. The load supporting frame multi-level wind turbine generator of claim 1, wherein the support frame has a subsidiary support frame installed individually at the front, rear, left and right of the support frame.

6. The load supporting frame multi-level wind turbine generator of claim 1, wherein the internal and external transmission shafts are formed by connecting a plurality of sections.

7. The load supporting frame multi-level wind turbine generator of claim 1, further comprising an inertia wheel installed between an axle of the generator and an axle of the first conical gear.

8. The load supporting frame multi-level wind turbine generator of claim 1, wherein the wind turbine set is formed by installing the multi-level frame wind turbines by a coaxial cable, and next level of the wind turbine is incremented from a previous level according to a specific ratio, and the first-level wind turbine is installed directly on an axle of a conical gear in the left and right large conical gears, and each wind turbine of other levels has a planetary gear system with a different transmission ratio for linking the left and right large conical gears.

9. The load supporting frame multi-level wind turbine generator of claim 1, wherein wind turbine support frame includes a wind direction instructing device installed on a windward side and having a wind vane, such that a switch is in contact with the wind vane under a wind direction, and the switch controls the hydraulic transmission device to drive the cross-shaped load rotating frame to move on the roller.
